(19) United States
(12) Patent Application Publication
(10) Pub. No.: US 2024/0381212 A1
(43) Pub. Date: Nov. 14, 2024

(54) APPARATUS COMPRISING AT LEAST ONE PROCESSOR

(71) Applicant: Nokia Technologies Oy, Espoo (FI)

(72) Inventors: Bernhard WEGMANN, Munich (DE); Irina-Mihaela BALAN, Munich (DE); Ahmad AWADA, Munich (DE); Ugur Baran ELMALI, Munich (DE)

(21) Appl. No.: 18/294,419

(22) PCT Filed: Aug. 5, 2021
(86) PCT No.: PCT/EP2021/071822

§ 371 Date: Feb. 1, 2024

(51) Int. Cl. H04W 36/36; H04W 76/38

(52) U.S. Cl. CPC H04W 36/362; H04W 76/38

(57) ABSTRACT

An apparatus comprising at least one processor, and at least one memory storing instructions, the at least one memory and the instructions configured to, with the at least one processor, cause a network device to determine a first information characterizing at least one of a) a number of cells prepared for a conditional handover or a conditional primary secondary cell change of a terminal device, b) a number of preparation activities associated with the conditional handover or the conditional primary secondary cell change of the terminal device.

### FIELD OF THE DISCLOSURE

Various example embodiments relate to an apparatus comprising at least one processor.

Further embodiments relate to a method of operating related to such apparatus.

### BACKGROUND

Wireless communications systems may e.g. be used for wireless exchange of information between two or more entities, e.g. comprising one or more terminal devices, e.g. user equipment, and one or more network devices such as e.g. base stations.

Some terminal devices may perform a conditional handover from a source node to a target node, wherein the terminal device, after receipt of a handover command, waits until at least one execution condition is fulfilled, prior to executing the handover.

### SUMMARY

Various embodiments of the disclosure are set out by the independent claims. The exemplary embodiments and features, if any, described in this specification, that do not fall under the scope of the independent claims, are to be interpreted as examples useful for understanding various exemplary embodiments of the disclosure.

Some exemplary embodiments relate to an apparatus, comprising at least one processor, and at least one memory storing instructions, the at least one memory and the instructions configured to, with the at least one processor, cause a network device to determine a first information characterizing at least one of a) a number of cells prepared for a conditional handover or a conditional primary secondary cell change of a terminal device, b) a number of preparation activities associated with the conditional handover or the conditional primary secondary cell change of the terminal device.

In some embodiments, the apparatus may be an apparatus for a wireless communications system.

In some embodiments, the apparatus or its functionality, respectively, may be provided in a network device, for example network node, of the communications system, for example in a base station, e.g. gNodeB (gNB).

In some embodiments, the apparatus according to the embodiments or its functionality, respectively, may be used for or within wireless communications systems, e.g. networks, based on or at least partially adhering to third generation partnership project, 3GPP, radio standards such as 5G (fifth generation) or other radio access technology.

In some embodiments, the apparatus according to the embodiments may be used to detect too many unnecessary conditional handover, CHO, and/or Conditional PSCell Change, CPC, target cell preparations during the CHO (and/or CPC) procedure, which, in some embodiments may be counted, e.g. as a, for example, negative performance indicator. In some embodiments, evaluations based on the first information such as e.g. the performance indicator, may be used in an a-posteriori optimization scheme like Mobility Robustness Optimization, MRO.

CHO has been introduced for LTE and 5G-NR communication networks to minimize radio link failures (RLFs) and handover failures (HOFs) resulting from timing issues along with mobility-triggered cell changes. Intra-frequency handovers are challenged by a very precise timing, and CHO is an option to relax the handover timing accuracy by decoupling the preparation of (potential) target cells from handover execution.

With respect to CHO, a terminal device such as a UE may be configured with two measurement events:

A first measurement event triggers preparation of the target cells. The UE will be configured with this first measurement event along with connection establishment with a serving cell. A second measurement event triggers the handover execution which may be done by UE autonomously according to the CHO principle.

In some systems, the second measurement event may be configured by the source cell when target cell preparation is completed with a RRCReconfiguration message.

In some systems, a configured event triggers the UE to send a measurement report. Based on this report, a source node can prepare one or more target cells for the same UE, where those targets cells can be served by multiple target nodes for the (conditional) handover (CHO Request+CHO Request Acknowledge) and then send an RRC Reconfiguration (CHO command) to the UE.

In case of a conventional handover (HO) (as opposed to the CHO), the UE may immediately access the target cell to complete the handover. Instead, in case of the CHO, the UE may only access the target cell once an additional CHO execution condition is met (i.e., the HO preparation and execution phases are decoupled). The condition may be configured by the source node.

The advantage of the CHO is that the CHO command can be sent very early, when the UE is served still safe in the source cell, without risking an early access to the target cell. As a result, the number of Radio Link Failures (RLFs) and handover failures (HoFs) may be reduced when using CHO.

In the following, some information elements, IEs, for example ASN.1 IEs, related to CHO configuration are explained:

-- ASN1START
-- TAG-CONDRECONFIGTOADDMODLIST-START
CondReconfigToAddModList-r16 ::= SEQUENCE (SIZE (1..
maxNrofCondCells-r16)) OF CondReconfigToAddMod-r16

| | |
|---|---|
| CondReconfigToAddMod-r16 ::= | SEQUENCE { |
| condReconfigId-r16 | CondReconfigId-r16, |
| condExecutionCond-r16 | SEQUENCE (SIZE (1..2)) OF |
| MeasId | OPTIONAL, -- Cond |

condReconfigAdd

| | |
|---|---|
| condRRCReconfig-r16 | OCTET STRING (CONTAINING |
| RRCReconfiguration) | OPTIONAL, -- Cond |

condReconfigAdd
...
}
-- TAG-CONDRECONFIGTOADDMODLIST-STOP

In some systems, condReconfigId-r16 identifies a CHO configuration with respect to a prepared target cell.

In some systems, condExecutionCond-r16 identifies the CHO execution condition that needs to be fulfilled in order to trigger the execution of a conditional reconfiguration (configured by source cell).

In some systems, condRRCReconfig-r16 contains the RRC Reconfiguration to be applied when the condition is fulfilled (provided by the target cell).

In some systems, for the CHO preparation phase, typically A3 or A5 events may be used, while for CHO execution new events have been introduced (CondEventA3, CondEventA5), since these events do not trigger a reporting when they are met but rather the UE applies the conditional reconfiguration of the target cell and starts execution of the cell change.

In some systems, the price to be paid with CHO for the timely more relaxed handover is the uncertainty of preparing the right target cell of the handover, i.e., the UE will access only one target cell out of several prepared ones.

In some systems, the preparation of a large set of potential target cells causes a waste of resources by blocking a high number of resources in the potential target cells. If on the other hand, the set of prepared target cells is too small, the risk of wrong cell preparation leading to RLF would increase, or the set of prepared target cells needs in this case to be regularly updated which results in lot of signaling as unwanted side effect.

In some embodiments, it is assumed that the measurement event A3 is applied for both preparation (here for example: A3_prep) and execution (here for example: A3_exec), for example with different handover parameters such that A3_prep is met earlier than the A3_exec. In some embodiments, as previously explained, some accepted standards also allow the measurement event A5 to be used, sometimes in combination with A3, for example in case of dual-event CHO execution.

In some systems, the CHO procedure has been recently extended to Primary Secondary Cell (PSCell) change in dual-connectivity (DC), where a terminal device, e.g. a UE, may simultaneously use two links of two (for example different) frequencies or even Radio Access Technology (RAT) layers, which may be denoted as Multi-RAT Dual-Connectivity (MR-DC). In some systems, the corresponding procedure is called Conditional PSCell Change (CPC) for the Primary Secondary Cell (PSCell) changes.

In some systems, CPC may have two flavors: Master Node (MN)-initiated CPC and Secondary Node (SN)-initiated CPC. Furthermore, in some systems, the setup (e.g., an addition procedure) of a second link may be realized as a conditional procedure, which may be denoted as Conditional PSCell Addition (CPA).

In some embodiments, the principle according to the embodiments may be applied to non-DC configurations, e.g. “conventional” CHOs, but also to CPC and CPA.

In some embodiments, preparation activities may include measurement event reporting and/or Xn Application Protocol (XnAP) signaling, for example for preparation and/or release and/or replacement (which can be as well seen as a preparation of a new cell and release of another at the same time).

In some embodiments, the first information further comprises at least one of: c) a cell ID, for example a Cell Global Identity, GCI, and/or a Physical Cell ID, PCI, of at least one cell prepared for the terminal device during a predetermined time span, d) a time duration a cell has been prepared for the terminal device, for example before being released or until the conditional handover or the conditional primary secondary cell change is made, e) an order of cells prepared for the terminal device.

In some embodiments, the PCI of the prepared cell may be part of a condRRCReconfig-r16 according to some accepted standards, e.g. containing a RRC Reconfiguration prepared by the target cell. As such, in some embodiments, the terminal device may decode the RRC Reconfiguration, e.g. to know the PCI of the prepared cell.

In some embodiments, for example to avoid the decoding of condRRCReconfig-r16, the source cell can include the PCI of the prepared cell as part of CondReconfigToAddMod-r16 (i.e., outside condRRCReconfig-r16).

In some embodiments, the instructions, when executed by the at least one processor, further cause the network device to: at least temporarily store the first information.

In some embodiments, the storing or logging of data, e.g. comprising the first information, may be performed by and/or within the network device, for example gNB, hosting a serving cell where the terminal device starting the CHO/CPC process is connected to.

In some embodiments, a memory foreseen for UE specific data storage (e.g. UE context) may be extended by one or more information elements, e.g. for storing at least parts of the first information.

In some embodiments, at least two integer variables may be provided, for example for storing the number of prepared cells and the number of preparation activities.

In some embodiments, more than two integer variables may be provided, e.g. for storing more details like the cell IDs (e.g., CGIs/PCIs) of the cells which are/were prepared during the considered time span, for example including the one for which the UE has performed CHO execution.

I.e., in some embodiments, data to be stored in the context of storing the first information may include also cells which have been prepared but which have been released later on before CHO execution. In some embodiments, also a time duration a cell has been prepared before being released or till CHO execution is met may be stored.

In some embodiments, the instructions, when executed by the at least one processor, further cause the network device to: provide the first information to at least one further entity, e.g. for collecting, e.g. logging, the first information, and/or for evaluation. In some embodiments, the at least one further entity may be an apparatus configured to perform Mobility Robustness Optimization, MRO, functions and/or Self-Optimizing Network, SON, functions.

Further exemplary embodiments relate to a method comprising: determining, by a network device, a first information characterizing at least one of a) a number of cells prepared for a conditional handover or a conditional primary secondary cell change of a terminal device, b) a number of preparation activities associated with the conditional handover or the conditional primary secondary cell change of the terminal device.

Further exemplary embodiments relate to an apparatus comprising means for causing a network device to determine a first information characterizing at least one of a) a number of cells prepared for a conditional handover or a conditional primary secondary cell change of a terminal device, b) a number of preparation activities associated with the conditional handover or the conditional primary secondary cell change of the terminal device. In some embodiments, the means for causing the network device to determine the first information may comprise at least one processor, and at least one memory storing instructions, the at least one memory and the instructions configured to, with the at least one processor, perform said step of causing the network device to determine the first information.

Further exemplary embodiments relate to an apparatus comprising at: least one processor, and at least one memory storing instructions, the at least one memory and the instructions configured to, with the at least one processor, cause a terminal device to determine an information, for example a second information, characterizing at least one of a) a cell ID, for example a Physical Cell ID, PCI, of at least one cell prepared for a conditional handover or a conditional primary secondary cell change of the terminal device, b) an order of cells prepared for the terminal device, c) a cell ID, for example PCI, of at least one cell prepared for the terminal device which has been released before an execution of the conditional handover or the conditional primary secondary cell change, d) an order of cells prepared for the terminal device which has been released before an execution of the conditional handover or the conditional primary secondary cell change, e) a cell, for example cell ID of a cell, to which the conditional handover or the conditional primary secondary cell change has been successfully executed.

In some embodiments, the apparatus or its functionality, respectively, may be provided in a terminal device, for example user equipment, of a communications system.

In some embodiments, the apparatus according to the embodiments or its functionality, respectively, may be used for or within wireless communications systems, e.g. networks, based on or at least partially adhering to third generation partnership project, 3GPP, radio standards such as 5G (fifth generation) or other radio access technology.

In some embodiments, the instructions, when executed by the at least one processor, further cause the terminal device to at least temporarily store the second information.

In some embodiments, the instructions, when executed by the at least one processor, further cause the terminal device to provide at least a part of the second information to at least one further entity, e.g. an apparatus configured to perform Mobility Robustness Optimization, MRO, functions and/or Self-Optimizing Network, SON, functions.

In some embodiments, providing at least a part of the second information to the at least one further entity comprises including the at least one part of the second information in a Successful Handover Report. In other words, in some embodiments, a Successful Handover Report, e.g. according to some accepted standards, may be used for providing the at least one part of the second information, e.g. by extending the Successful Handover Report according to some accepted standards by adding at least a part of the second information.

Further exemplary embodiments relate to a method comprising: determining, by a terminal device, an information, for example a second information, characterizing at least one of a) a cell ID, for example a Physical Cell ID, PCI, of at least one cell prepared for a conditional handover or a conditional primary secondary cell change of the terminal device, b) an order of cells prepared for the terminal device, c) a cell ID, for example PCI, of at least one cell prepared for the terminal device which has been released before an execution of the conditional handover or the conditional primary secondary cell change, d) an order of cells prepared for the terminal device which has been released before an execution of the conditional handover or the conditional primary secondary cell change, e) a cell, for example cell ID of a cell, to which the conditional handover or the conditional primary secondary cell change has been successfully executed.

Further exemplary embodiments relate to an apparatus comprising means for causing a terminal device to determine an information, for example a second information, characterizing at least one of a) a cell ID, for example a Physical Cell ID, PCI, of at least one cell prepared for a conditional handover or a conditional primary secondary cell change of the terminal device, b) an order of cells prepared for the terminal device, c) a cell ID, for example PCI, of at least one cell prepared for the terminal device which has been released before an execution of the conditional handover or the conditional primary secondary cell change, d) an order of cells prepared for the terminal device which has been released before an execution of the conditional handover or the conditional primary secondary cell change, e) a cell, for example cell ID of a cell, to which the conditional handover or the conditional primary secondary cell change has been successfully executed. In some embodiments, the means for causing the terminal device to determine the second information may comprise at least one processor, and at least one memory storing instructions, the at least one memory and the instructions configured to, with the at least one processor, perform said step of causing the terminal device to determine the second information.

Further exemplary embodiments relate to a method, comprising: retrieving at least one of a first information and a second information, the first information characterizing at least one of a) a number of cells prepared for a conditional handover or a conditional primary secondary cell change of a terminal device, b) a number of preparation activities associated with the conditional handover or the conditional primary secondary cell change of the terminal device, the second information characterizing at least one of a) a cell ID, for example a Physical Cell ID, PCI, of at least one cell prepared for a conditional handover or a conditional primary secondary cell change of the terminal device, b) an order of cells prepared for the terminal device, c) a cell ID, for example PCI, of at least one cell prepared for the terminal device which has been released before an execution of the conditional handover or the conditional primary secondary cell change, d) an order of cells prepared for the terminal device which has been released before an execution of the conditional handover or the conditional primary secondary cell change, e) a cell, for example cell ID of a cell, to which the conditional handover or the conditional primary secondary cell change has been successfully executed, the method further comprising: determining, based on at least one of the first information and the second information, a cost parameter characterizing a cost and/or an effort associated with the conditional handover or the conditional primary secondary cell change of the terminal device. In some embodiments, the method may be performed by an apparatus configured to perform Mobility Robustness Optimization, MRO, functions and/or Self-Optimizing Network, SON, functions.

In some embodiments, the method further comprises at least one of the following elements: a) incrementing a counter based on the cost parameter, b) deleting at least one of a first information and a second information.

In some embodiments, the counter may be a performance counter, which may e.g. characterize a degree of an unnecessary preparation of e.g. CHO and/or CPC. In some embodiments, the counter may be associated with an MRO instance that is associated with a (currently) serving cell and/or type of the terminal device, e.g. UE type, etc. This enables to determine and/or characterize a degree of unnecessary CHO preparations and/or unnecessary CPC preparations related to the specific cell and/or UE or UE type.

Further exemplary embodiments relate to an apparatus, comprising at least one processor, and at least one memory storing instructions, the at least one memory and the instructions configured to, with the at least one processor, retrieve at least one of a first information and a second information, the first information characterizing at least one of a) a number of cells prepared for a conditional handover or a conditional primary secondary cell change of a terminal device, b) a number of preparation activities associated with the conditional handover or the conditional primary secondary cell change of the terminal device, the second information characterizing at least one of a) a cell ID, for example a Physical Cell ID, PCI, of at least one cell prepared for a conditional handover or a conditional primary secondary cell change of the terminal device, b) an order of cells prepared for the terminal device, c) a cell ID, for example PCI, of at least one cell prepared for the terminal device which has been released before an execution of the conditional handover or the conditional primary secondary cell change, d) an order of cells prepared for the terminal device which has been released before an execution of the conditional handover or the conditional primary secondary cell change, e) a cell, for example cell ID of a cell, to which the conditional handover or the conditional primary secondary cell change has been successfully executed, and to: determine, based on at least one of the first information and the second information, a cost parameter characterizing a cost and/or an effort associated with the conditional handover or the conditional primary secondary cell change of the terminal device.

Further exemplary embodiments relate to an apparatus comprising means for retrieving at least one of a first information and a second information, the first information characterizing at least one of a) a number of cells prepared for a conditional handover or a conditional primary secondary cell change of a terminal device, b) a number of preparation activities associated with the conditional handover or the conditional primary secondary cell change of the terminal device, the second information characterizing at least one of a) a cell ID, for example a Physical Cell ID, PCI, of at least one cell prepared for a conditional handover or a conditional primary secondary cell change of the terminal device, b) an order of cells prepared for the terminal device, c) a cell ID, for example PCI, of at least one cell prepared for the terminal device which has been released before an execution of the conditional handover or the conditional primary secondary cell change, d) an order of cells prepared for the terminal device which has been released before an execution of the conditional handover or the conditional primary secondary cell change, e) a cell, for example cell ID of a cell, to which the conditional handover or the conditional primary secondary cell change has been successfully executed, the means further configured to determine, based on at least one of the first information and the second information, a cost parameter characterizing a cost and/or an effort associated with the conditional handover or the conditional primary secondary cell change of the terminal device. In some embodiments, the means for retrieving the at least one of a first information and a second information may comprise at least one processor, and at least one memory storing instructions, the at least one memory and the instructions configured to, with the at least one processor, perform said step of retrieving.

Further exemplary embodiments relate to an apparatus comprising at least one processor, and at least one memory storing instructions, the at least one memory and the instructions configured to, with the at least one processor, cause a network device to receive an information, for example a second information, characterizing at least one of a) a cell ID of at least one cell prepared for a conditional handover or a conditional primary secondary cell change of a terminal device, b) an order of cells prepared for the terminal device, c) a cell ID of at least one cell prepared for the terminal device which has been released before an execution of the conditional handover or the conditional primary secondary cell change, d) an order of cells prepared for the terminal device which has been released before an execution of the conditional handover or the conditional primary secondary cell change, e) a cell, for example cell ID of a cell, to which the conditional handover or the conditional primary secondary cell change has been successfully executed.

In some embodiments, the instructions, when executed by the at least one processor, further cause the network device to at least temporarily store the second information.

In some embodiments, the instructions, when executed by the at least one processor, further cause the network device to provide at least a part of the second information to at least one further entity.

Further exemplary embodiments relate to an apparatus comprising means for causing a network device to receive an information, for example a second information, characterizing at least one of a) a cell ID, b) an order of cells prepared for the terminal device, c) a cell ID of at least one cell prepared for the terminal device which has been released before an execution of the conditional handover or the conditional primary secondary cell change, d) an order of cells prepared for the terminal device which has been released before an execution of the conditional handover or the conditional primary secondary cell change, e) a cell, for example cell ID of a cell, to which the conditional handover or the conditional primary secondary cell change has been successfully executed.

Further exemplary embodiments relate to a method, comprising: receiving an information, for example a second information, characterizing at least one of a) a cell ID of at least one cell prepared for a conditional handover or a conditional primary secondary cell change of a terminal device, b) an order of cells prepared for the terminal device, c) a cell ID of at least one cell prepared for the terminal device which has been released before an execution of the conditional handover or the conditional primary secondary cell change, d) an order of cells prepared for the terminal device which has been released before an execution of the conditional handover or the conditional primary secondary cell change, e) a cell, for example cell ID of a cell, to which the conditional handover or the conditional primary secondary cell change has been successfully executed, the method further comprising: determining, based on at least one of the first information and the second information, a cost parameter characterizing a cost and/or an effort associated with the conditional handover or the conditional primary secondary cell change of the terminal device. Further exemplary embodiments relate to a wireless communications system comprising at least one apparatus according to the embodiments.

### BRIEF DESCRIPTION OF THE FIGURES

FIG. 1 schematically depicts a simplified block diagram of an apparatus according to some embodiments,

FIG. 2 schematically depicts a simplified block diagram of an apparatus according to some embodiments,

FIG. 3 schematically depicts a simplified block diagram according to some embodiments,

FIG. 4 schematically depicts a simplified flow chart according to some embodiments,

FIG. 5 schematically depicts a simplified block diagram according to some embodiments,

FIG. 6 schematically depicts a simplified flow chart according to some embodiments,

FIG. 7 schematically depicts a simplified block diagram according to some embodiments,

FIG. 8 schematically depicts a simplified flow chart according to some embodiments,

FIG. 9 schematically depicts a simplified block diagram according to some embodiments

FIG. 10 schematically depicts a simplified operational scenario according to some embodiments,

FIG. 11 schematically depicts a simplified time diagram according to some embodiments,

FIG. 12 schematically depicts a simplified flow chart according to some embodiments,

FIG. 13 schematically depicts a simplified flow chart according to some embodiments,

FIG. 14 schematically depicts a simplified block diagram according to some embodiments,

FIG. 15 schematically depicts a simplified block diagram according to some embodiments,

FIG. 16 schematically depicts a simplified block diagram according to some embodiments,

FIG. 17 schematically depicts a simplified block diagram according to some embodiments,

FIG. 18 schematically depicts a simplified block diagram according to some embodiments,

FIG. 19 schematically depicts a simplified flow chart according to some embodiments.

### DESCRIPTION OF SOME EXEMPLARY EMBODIMENTS

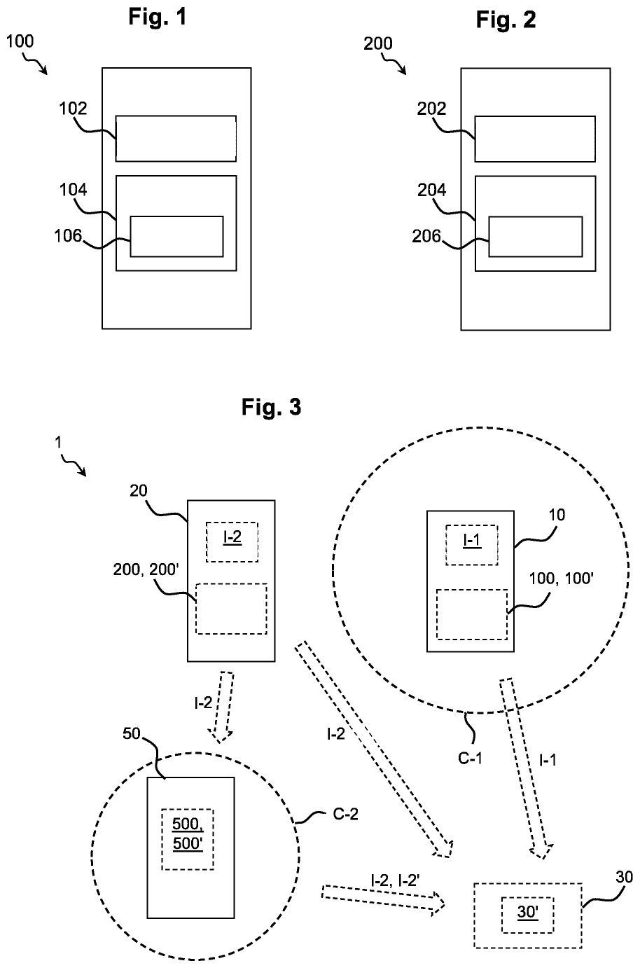

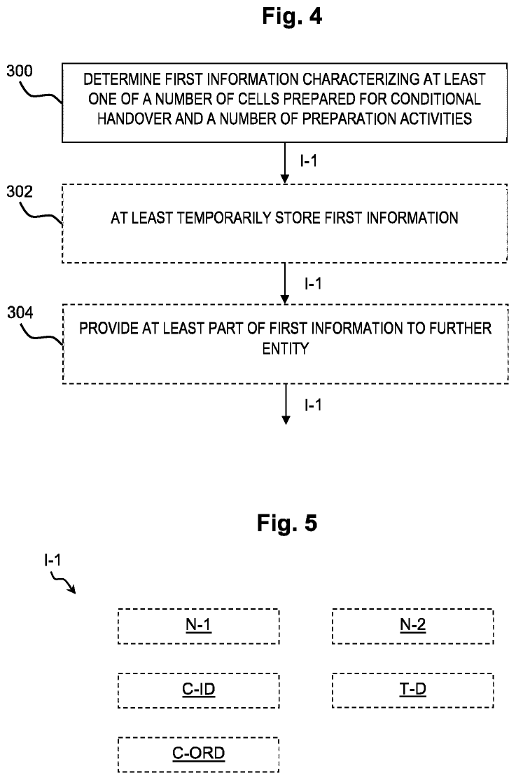

Some exemplary embodiments, see for example FIGS. 1, 3, 4, 5, relate to an apparatus 100, comprising at least one processor 102, and at least one memory 104 storing instructions 106, the at least one memory 104 and the instructions 106 configured to, with the at least one processor 102, cause a network device 10 (FIG. 2) to determine 300 (FIG. 4) a first information I-1 characterizing at least one of a) a number N-1 (FIG. 5) of cells prepared for a conditional handover, CHO, or a conditional primary secondary cell, PSCell, change, CPC, of a terminal device 20, b) a number N-2 of preparation activities associated with the conditional handover or the conditional primary secondary cell change of the terminal device 20.

In some embodiments, the apparatus 100 may be an apparatus for a wireless communications system 1 (FIG. 3).

In some embodiments, the apparatus 100 or its functionality, respectively, may be provided in a network device 10, for example network node, of the communications system, for example in a base station, e.g. gNodeB (gNB) 10.

In some embodiments, the apparatus 100 according to the embodiments or its functionality, respectively, may be used for or within wireless communications systems, e.g. networks, based on or at least partially adhering to third generation partnership project, 3GPP, radio standards such as 5G (fifth generation) or other radio access technology.

In some embodiments, the apparatus 100 according to the embodiments may be used to detect, for example too many, for example unnecessary, conditional handover, CHO, and/or Conditional PSCell Change, CPC, target cell preparations during the CHO (and/or CPC) procedure, which, in some embodiments may be counted, e.g. as a, for example, negative performance indicator. In some embodiments, evaluations based on the first information I-1 such as e.g. the performance indicator, may be used in an a-posteriori optimization scheme like Mobility Robustness Optimization, MRO.

CHO has been introduced for LTE and 5G-NR communication networks to minimize radio link failures (RLFs) and handover failures (HOFs) resulting from timing issues along with mobility-triggered cell changes. Intra-frequency handovers are challenged by a very precise timing, and CHO is an option to relax the handover timing accuracy by decoupling the preparation of (potential) target cells from handover execution.

With respect to CHO, a terminal device 20 (FIG. 3) such as a UE may be configured with two measurement events:

A first measurement event triggers preparation of the target cells C-2. The UE 20 will be configured with this first measurement event along with connection establishment with a serving cell C-1. A second measurement event triggers the handover execution which may be done by UE 20 autonomously according to the CHO principle.

In some systems, the second measurement event may be configured by the source cell C-1 when target cell preparation is completed with a RRCReconfiguration message according to some accepted standards.

In some systems, a configured event triggers the UE 20 to send a measurement report. Based on this report, a source node 10 can prepare one or more target cells C-2 for the same UE 20, or multiple target nodes for the (conditional) handover (CHO Request+CHO Request Acknowledge) and then send an RRC Reconfiguration (CHO command) to the UE 20.

In case of a conventional handover (HO) (as opposed to the CHO), the UE 20 may immediately access the target cell C-2 to complete the handover. Instead, in case of the CHO, the UE 20 may only access the target cell C-2 once an additional CHO execution condition is met (i.e., the HO preparation and execution phases are decoupled). The condition may be configured by the source node C-1.

The advantage of the CHO is that the CHO command can be sent very early, when the UE 20 is served still safe in the source cell C-1, without risking an early access to the target cell C-2. As a result, the number of Radio Link Failures (RLFs) and handover failures (HoFs) may be reduced when using CHO.

In the following, some information elements, IEs, for example ASN.1 IEs, related to CHO configuration are explained:

-- ASN1START
-- TAG-CONDRECONFIGTOADDMODLIST-START
CondReconfigToAddModList-r16 ::= SEQUENCE (SIZE (1..
maxNrofCondCells-r16)) OF CondReconfigToAddMod-r16
CondReconfigToAddMod-r16 ::= SEQUENCE {

| | |
|---|---|
| condReconfigId-r16 | CondReconfigId-r16, condExecutionCond- |

r16 SEQUENCE (SIZE (1..2)) OF MeasId
OPTIONAL,
-- Cond condReconfigAdd

| | |
|---|---|
| condRRCReconfig-r16 | OCTET STRING (CONTAINING |
| RRCReconfiguration) | OPTIONAL, |

-- Cond condReconfigAdd
...
}
-- TAG-CONDRECONFIGTOADDMODLIST-STOP

In some systems, condReconfigId-r16 identifies a CHO configuration with respect to a prepared target cell.

In some systems, condExecutionCond-r16 identifies the CHO execution condition that needs to be fulfilled in order to trigger the execution of a conditional reconfiguration (configured by source cell).

In some systems, condRRCReconfig-r16 contains the RRC Reconfiguration to be applied when the condition is fulfilled (provided by the target cell).

In some systems, for the CHO preparation phase, typically A3 or A5 events may be used, while for CHO execution new events may be introduced (for example CondEventA3, CondEventA5), since these events do not trigger a reporting when they are met but rather the UE applies the conditional reconfiguration of the target cell and starts execution of the cell change.

In some systems, the price to be paid with CHO for the timely more relaxed handover is the uncertainty of preparing the right target cell of the handover, i.e., the UE will access only one target cell out of the up to 8 prepared ones.

In some systems, the preparation of a large set of potential target cells causes a waste of resources by blocking a high number of resources in the potential target cells. If on the other hand, the set of prepared target cells is too small, the risk of wrong cell preparation leading to RLF would be rather higher, or the set of prepared target cells needs in this case to be regularly updated which results in lot of signaling as unwanted side effect.

In some embodiments, it is assumed that the measurement event A3 is applied for both preparation (here for example: A3_prep) and execution (here for example: A3_exec), for example with different handover parameters such that A3_prep is met earlier than the A3_exec. In some embodiments, as previously explained, some accepted standards also allow the measurement event A5 to be used, sometimes in combination with A3, for example in case of dual-event CHO execution.

In some systems, the CHO procedure has been recently extended to Primary Secondary Cell (PSCell) change in dual-connectivity (DC), where a terminal device, e.g. a UE, may simultaneously use two links of two (for example different) frequencies or even Radio Access Technology (RAT) layers, which may be denoted as Multi-RAT Dual-Connectivity (MR-DC). In some systems, the corresponding procedure is called Conditional PSCell Change (CPC) for the Primary Secondary Cell (PSCell) changes.

In some systems, CPC may have two flavors: Master Node (MN)-initiated CPC and Secondary Node (SN)-initiated CPC. Furthermore, in some systems, the setup (e.g., an addition procedure) of a second link may be realized as a conditional procedure, which may be denoted as Conditional PSCell Addition (CPA).

In some embodiments, the principle according to the embodiments may be applied to non-DC configurations, e.g. “conventional” CHOs, but also to CPC and CPA.

In some embodiments, FIG. 5, the first information I-1 further comprises at least one of: c) a cell ID C-ID, for example a Cell Global Identity, GCI, and/or a Physical Cell ID, PCI, of at least one cell C-2 (FIG. 3) prepared for the terminal device 20 during a predetermined time span, d) a time duration T-D (FIG. 5) a cell has been prepared for the terminal device 20, for example before being released or until the conditional handover or the conditional primary secondary cell change is made, e) an order C-ORD (FIG. 5) of cells prepared for the terminal device 20.

In some embodiments, the instructions 106 (FIG. 1), when executed by the at least one processor 102, further cause the network device 10 (FIG. 3) to: at least temporarily store 302 (FIG. 4) the first information I-1, for example for a, for example subsequent, evaluation and/or transmission to another entity.

In some embodiments, the storing 302 or logging of data, e.g. comprising the first information I-1 or at least parts thereof, may be performed by and/or within the network device 10 (FIG. 3), for example gNB, hosting a serving cell C-1 where the terminal device 20 starting the CHO/CPC process is connected to.

In some embodiments, a memory (for example memory 104 of apparatus 100 of FIG. 1) foreseen for UE specific data storage (e.g. UE context) may be extended by one or more information elements, e.g. for storing at least parts of the first information I-1, for example at least one or at least some of the elements N-1, N-2, C-ID, T-D, C-ORD exemplarily depicted by FIG. 5.

In some embodiments, at least two integer variables may be provided, for example for storing the number N-1 of prepared cells and the number N-2 of preparation activities.

In some embodiments, more than two integer variables may be provided, e.g. for storing more details like the cell IDs (e.g., CGIs/PCIs) C-ID of the cells which are/were prepared during the considered time span, for example including the one for which the UE 20 has performed CHO execution.

I.e., in some embodiments, data to be stored in the context of storing 302 the first information I-1 may include also cells which have been prepared but which have been released later on before CHO execution. In some embodiments, also a time duration a cell has been prepared before being released or till CHO execution is met may be stored.

In some embodiments, the instructions 106 (FIG. 1), when executed by the at least one processor 102, further cause the network device 10 (FIG. 3) to: provide 304 (FIG. 4) the first information I-1 (or at least a part of the first information I-1) to at least one further entity 30 (FIG. 3), e.g. for collecting, e.g. logging, the first information I-1, and/or for evaluation. In some embodiments, the at least one further entity 30 may be an apparatus configured to perform Mobility Robustness Optimization, MRO, functions and/or Self-Optimizing Network, SON, functions.

Further exemplary embodiments, FIG. 4, relate to a method comprising: determining 300, by a network device 10, a first information I-1 characterizing at least one of a) a number N-1 of cells prepared for a conditional handover or a conditional primary secondary cell change of a terminal device 20, b) a number N-2 of preparation activities associated with the conditional handover or the conditional primary secondary cell change of the terminal device 20. In some embodiments, the method may comprise further optional elements, see for example blocks 302, 304 of FIG. 4.

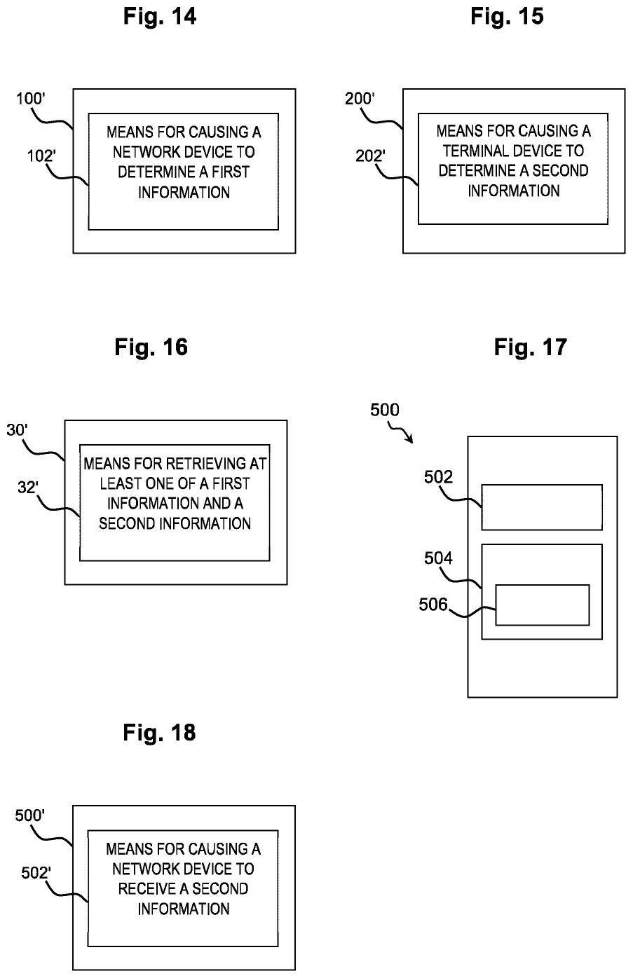

Further exemplary embodiments, FIG. 14, relate to an apparatus 100′ comprising means 102′ for causing a network device 10 to determine 300 a first information I-1 characterizing at least one of a) a number N-1 of cells prepared for a conditional handover or a conditional primary secondary cell change of a terminal device 20, b) a number N-2 of preparation activities associated with the conditional handover or the conditional primary secondary cell change of the terminal device 20. In some embodiments, the means 102′ for causing the network device 10 to determine 300 the first information I-1 may comprise at least one processor 102, and at least one memory 104 storing instructions 106, the at least one memory 104 and the instructions 106 configured to, with the at least one processor 102, perform said step 300 of causing the network device 10 to determine 300 the first information I-1.

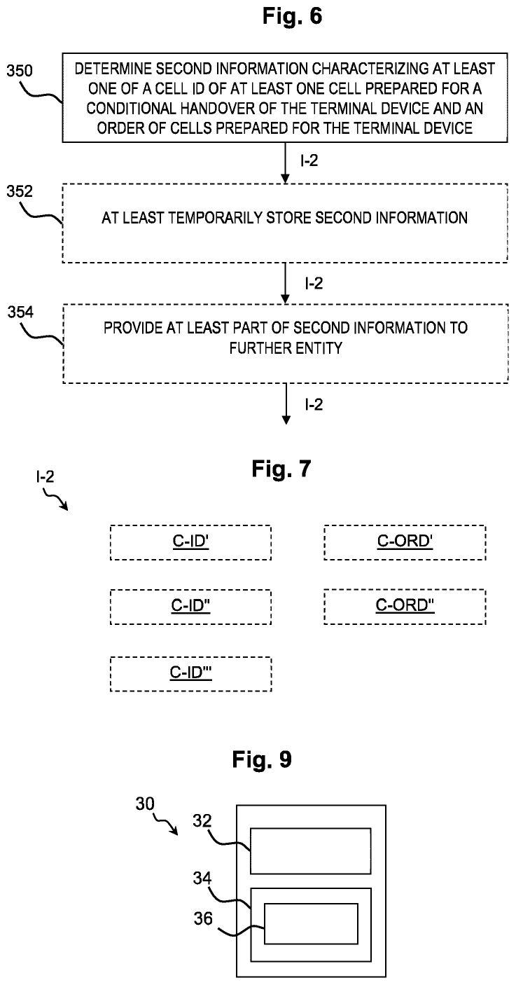

Further exemplary embodiments, see for example FIGS. 2, 3, 6, 7, relate to an apparatus 200 comprising at least one processor 202, and at least one memory 204 storing instructions 206, the at least one memory 204 and the instructions 206 configured to, with the at least one processor 202, cause a terminal device 20 (FIG. 3) to determine 350 (FIG. 6) an information I-2, for example a second information I-2, characterizing at least one of a) a cell ID, for example a Physical Cell ID, PCI, C-ID′ (FIG. 7) of at least one cell C-2 prepared for a conditional handover or a conditional primary secondary cell change of the terminal device 20, b) an order C-ORD′ of cells prepared for the terminal device 20, c) a cell ID, for example PCI, C-ID″ of at least one cell prepared for the terminal device 20 which has been released before an execution of the conditional handover or the conditional primary secondary cell change, d) an order C-ORD″ of cells prepared for the terminal device 20 which has been released before an execution of the conditional handover or the conditional primary secondary cell change, e) a cell, for example cell ID C-ID′″ of a cell, to which the conditional handover or the conditional primary secondary cell change has been successfully executed.

In some embodiments, the apparatus 200 or its functionality, respectively, may be provided in a terminal device 20, for example user equipment 20, of a communications system 1.

In some embodiments, the apparatus 200 according to the embodiments or its functionality, respectively, may be used for or within wireless communications systems 1, e.g. networks, based on or at least partially adhering to third generation partnership project, 3GPP, radio standards such as 5G (fifth generation) or other radio access technology.

In some embodiments, the instructions 206, when executed by the at least one processor 202, further cause the terminal device 20 to at least temporarily store 352 (FIG. 6) the second information I-2, for example for a, for example subsequent, evaluation and/or transmission to another entity 10, 30.

In some embodiments, the instructions 206, when executed by the at least one processor 202, further cause the terminal device 20 to provide 354 at least a part of the second information I-2 to at least one further entity 10, 30, e.g. an apparatus 30 configured to perform Mobility Robustness Optimization, MRO, functions and/or Self-Optimizing Network, SON, functions (and/or to the network device 20).

In some embodiments, providing 354 at least a part of the second information I-2 to the at least one further entity 10, 30 comprises including the at least one part of the second information I-1 in a Successful Handover Report. In other words, in some embodiments, a Successful Handover Report, e.g. according to some accepted standards, may be used for providing 354 the at least one part of the second information I-2, e.g. by extending the Successful Handover Report according to some accepted standards by adding at least a part of the second information I-2.

Further exemplary embodiments, FIG. 6, relate to a method comprising: determining 350, by a terminal device 20, an information, for example a second information, I-2 characterizing at least one of a) a cell ID, for example a Physical Cell ID, PCI, C-ID′ of at least one cell prepared for a conditional handover or a conditional primary secondary cell change of the terminal device, b) an order C-ORD′ of cells prepared for the terminal device, c) a cell ID, for example PCI, C-ID″ of at least one cell prepared for the terminal device which has been released before an execution of the conditional handover or the conditional primary secondary cell change, d) an order C-ORD″ of cells prepared for the terminal device which has been released before an execution of the conditional handover or the conditional primary secondary cell change, e) a cell, for example cell ID C-ID′″ of a cell, to which the conditional handover or the conditional primary secondary cell change has been successfully executed.

Further exemplary embodiments, FIG. 15, relate to an apparatus 200′ comprising means 202′ for causing a terminal device 20 to determine 350 an information, for example a second information, I-2 characterizing at least one of a) a cell ID, for example a Physical Cell ID, PCI, of at least one cell prepared for a conditional handover or a conditional primary secondary cell change of the terminal device, b) an order of cells prepared for the terminal device, c) a cell ID, for example PCI, of at least one cell prepared for the terminal device which has been released before an execution of the conditional handover or the conditional primary secondary cell change, d) an order of cells prepared for the terminal device which has been released before an execution of the conditional handover or the conditional primary secondary cell change, e) a cell, for example cell ID of a cell, to which the conditional handover or the conditional primary secondary cell change has been successfully executed. In some embodiments, the means 202′ for causing the terminal device 20 to determine 350 the second information I-2 may comprise at least one processor 202, and at least one memory 204 storing instructions 206, the at least one memory 204 and the instructions 206 configured to, with the at least one processor 202, perform said step 350 of causing the terminal device 20 to determine the second information I-2.

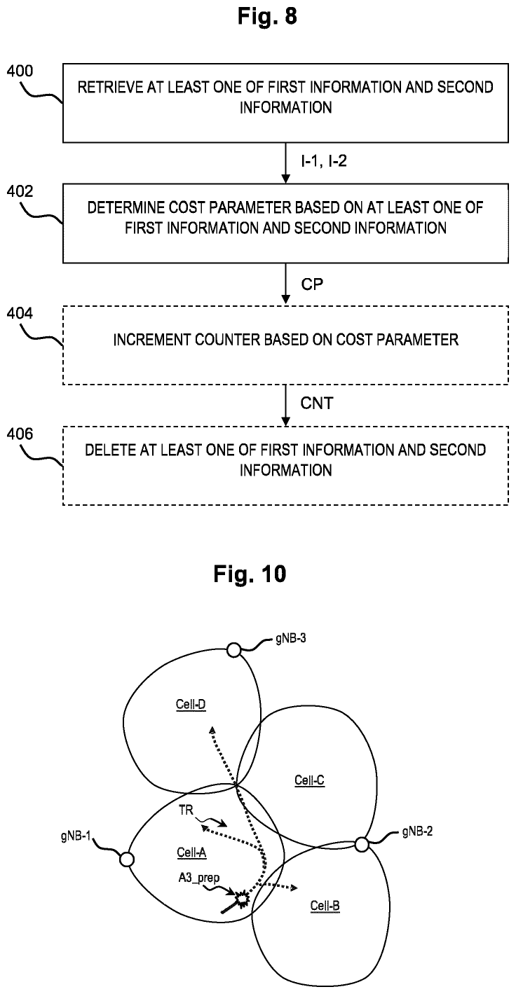

Further exemplary embodiments, see for example FIG. 8, relate to a method, comprising: retrieving 400 at least one of a first information I-1 and a second information I-2, the first information I-1 (FIG. 5) characterizing at least one of a) a number of cells prepared for a conditional handover or a conditional primary secondary cell change of a terminal device, b) a number of preparation activities associated with the conditional handover or the conditional primary secondary cell change of the terminal device, and/or further elements as exemplarily depicted by FIG. 5, the second information I-2 (FIG. 7) characterizing at least one of a) a cell ID, for example a Physical Cell ID, PCI, of at least one cell prepared for a conditional handover or a conditional primary secondary cell change of the terminal device, b) an order of cells prepared for the terminal device, c) a cell ID, for example PCI, of at least one cell prepared for the terminal device which has been released before an execution of the conditional handover or the conditional primary secondary cell change, d) an order of cells prepared for the terminal device which has been released before an execution of the conditional handover or the conditional primary secondary cell change, e) a cell, for example cell ID of a cell, to which the conditional handover or the conditional primary secondary cell change has been successfully executed, the method further comprising: determining 402, based on at least one of the first information I-1 and the second information I-2, a cost parameter CP characterizing a cost and/or an effort associated with the conditional handover or the conditional primary secondary cell change of the terminal device 20. In some embodiments, the method may be performed by an apparatus 30 (FIG. 9), which may e.g. be configured to perform Mobility Robustness Optimization, MRO, functions and/or Self-Optimizing Network, SON, functions.

In some embodiments, at least some of the elements of the method exemplarily depicted by FIG. 8 may at least temporarily be performed by the network device 10 and/or by the terminal device 20.

In some embodiments, FIG. 8, the method further comprises at least one of the following elements: a) incrementing 404 a counter CNT based on the cost parameter CP, b) deleting 406 at least one of the first information I-1 and the second information I-2, e.g., after an evaluation has been performed.

In some embodiments, the counter CNT may be a performance counter, which may e.g. characterize a degree of an unnecessary preparation of e.g. CHO and/or CPC. In some embodiments, the counter CNT may be associated with an MRO instance 30 (FIG. 3) that is associated with a (currently) serving cell C-1 and/or type of the terminal device 20, e.g. UE type, etc. In some embodiments, this enables to determine and/or characterize a degree of unnecessary CHO preparations and/or unnecessary CPC preparations related to the specific cell C-1 and/or UE 20 and/or UE type.

Further exemplary embodiments, FIG. 9, relate to an apparatus 30, comprising at least one processor 32, and at least one memory 34 storing instructions 36, the at least one memory 34 and the instructions 36 configured to, with the at least one processor 32, retrieve 400 (FIG. 8) at least one of a first information I-1 and a second information I-2, the first information characterizing at least one of a) a number of cells prepared for a conditional handover or a conditional primary secondary cell change of a terminal device, b) a number of preparation activities associated with the conditional handover or the conditional primary secondary cell change of the terminal device, the second information characterizing at least one of a) a cell ID, for example a Physical Cell ID, PCI, of at least one cell prepared for a conditional handover or a conditional primary secondary cell change of the terminal device, b) an order of cells prepared for the terminal device, c) a cell ID, for example PCI, of at least one cell prepared for the terminal device which has been released before an execution of the conditional handover or the conditional primary secondary cell change, d) an order of cells prepared for the terminal device which has been released before an execution of the conditional handover or the conditional primary secondary cell change, e) a cell, for example cell ID of a cell, to which the conditional handover or the conditional primary secondary cell change has been successfully executed, and to: determine 402, based on at least one of the first information I-1 and the second information I-2, a cost parameter CP characterizing a cost and/or an effort associated with the conditional handover or the conditional primary secondary cell change of the terminal device 20.

Further exemplary embodiments, FIG. 16, relate to an apparatus 30′ comprising means 32′ for retrieving 400 (FIG. 8) at least one of a first information I-1 and a second information I-2, the first information characterizing at least one of a) a number of cells prepared for a conditional handover or a conditional primary secondary cell change of a terminal device, b) a number of preparation activities associated with the conditional handover or the conditional primary secondary cell change of the terminal device, the second information characterizing at least one of a) a cell ID, for example a Physical Cell ID, PCI, of at least one cell prepared for a conditional handover or a conditional primary secondary cell change of the terminal device, b) an order of cells prepared for the terminal device, c) a cell ID, for example PCI, of at least one cell prepared for the terminal device which has been released before an execution of the conditional handover or the conditional primary secondary cell change, d) an order of cells prepared for the terminal device which has been released before an execution of the conditional handover or the conditional primary secondary cell change, e) a cell, for example cell ID of a cell, to which the conditional handover or the conditional primary secondary cell change has been successfully executed, the means 32′ further configured to determine 402, based on at least one of the first information I-1 and the second information I-2, a cost parameter CP characterizing a cost and/or an effort associated with the conditional handover or the conditional primary secondary cell change of the terminal device 20. In some embodiments, the means 32′ for retrieving the at least one of a first information and a second information may comprise at least one processor 32 (FIG. 9), and at least one memory 34 storing instructions 36, the at least one memory 34 and the instructions 36 configured to, with the at least one processor 32, perform said step of retrieving 400.

In some embodiments, the apparatus 30′ may be provided in an apparatus 30 (FIG. 3) configured to perform Mobility Robustness Optimization, MRO, functions and/or Self-Optimizing Network, SON, functions.

In some embodiments, the apparatus 30, 30′ may be provided in a network device 10 and/or in a terminal device 20. In some embodiments, the functionality of apparatus 30 and/or 30′ and of apparatus 100 and/or 100′ may also be combined, for example provided in a network device 10, e.g. gNB.

FIG. 10 schematically depicts a simplified operational scenario according to some embodiments. Exemplarily depicted is an environment wherein three network devices, for example gNBs gNB-1, gNB-2, gNB-3, provide radio cells Cell-A, Cell-B, Cell-C, Cell-D. Also depicted are potential trajectories TR, symbolized by dotted arrows, of a UE 20 (not shown in FIG. 10) within a region covered by at least some of the radio cells Cell-A, Cell-B, Cell-C, Cell-D.

The example of FIG. 10 exemplarily considers Primary Cell (PCell) (and CHO as the conditional handover procedure), however, a similar problem may also exist for PSCell and CPC as the conditional handover procedure. For the considered example, in some embodiments, two CHO-related measurement events may be configured as following:
a) A3_prep (for example configured with an A3_prep-Offset=3 dB) starts the preparation, i.e. UE 20 sends measurement report when neighbour RSRP (reference signal received power) (i.e., Measurement neighbour cell) denoted by Mn is less than 3 dB below of Measurement of serving cell denoted by Ms, i.e., Mn>Ms−3 dB. In some embodiments, since more than one cell can fulfil the preparation event A3_prep, the measurement report can contain the measurements of multiple cells and the receiving entity can decide which and how many target cells are to be prepared at this stage of the CHO procedure.
b) An execution event, here exemplarily called A3_exec, is triggered by a CondEventA3 measurement event with A3_exec-Offset=+3 dB, i.e. the UE 20 executes HO if neighbour RSRP Mn becomes 3 dB better than that of serving cell Ms (Mn>Ms+3 dB).

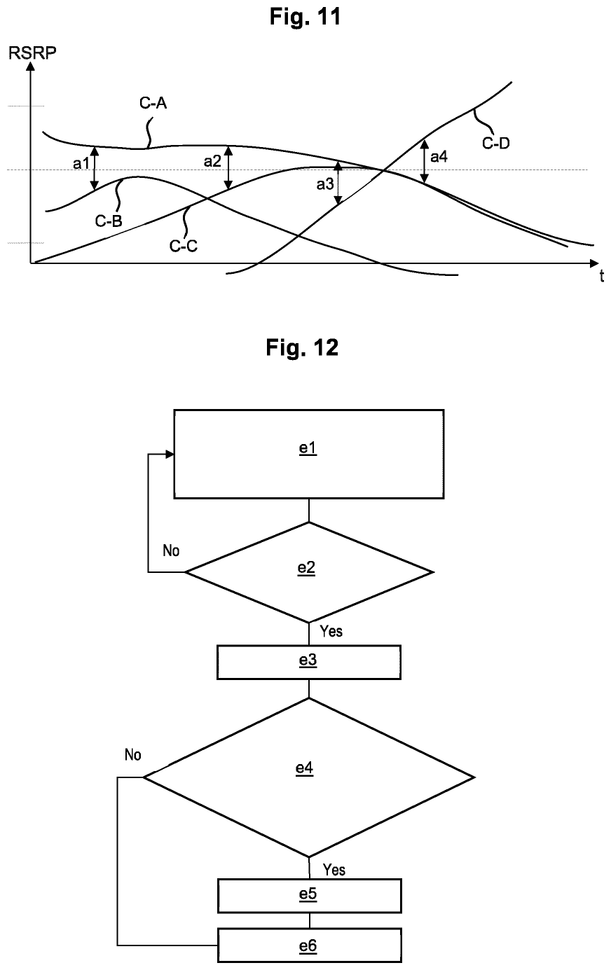

One potential problem being considered in the present example, which may be addressed by the principle according to the embodiments, is also visible in the exemplary time diagram of FIG. 11, which depicts a measured RSRP over time t during an exemplary CHO procedure along one of the trajectories TR towards cell Cell-D of gNB gNB-3. The curve C-A symbolizes the RSRP measurement associated with the cell Cell-A, the curve C-B symbolizes the RSRP measurement associated with the cell Cell-B, the curve C-C symbolizes the RSRP measurement associated with the cell Cell-C, and the curve C-D symbolizes the RSRP measurement associated with the cell Cell-D. The double arrows a1, a2, a3, a4 symbolize respective offsets, wherein the double arrows a1, a2, a3 for example symbolize respective A3_prep-Offsets of −3 dB, and wherein the double arrow a4 for example symbolizes the A3_exec-Offset of +3 dB.

As can be seen from FIGS. 10 and 11, some scenarios may lead to unnecessary target cell preparations like the cells Cell-B and Cell-C of gNB gNB-2, before the UE 20 finally ends up in cell Cell-D of the gNB gNB-3, which may cause a waste of network resources, even though the mobility procedure itself was successful. I.e., in some embodiments, the price for the flexibility related to CHO and/or CPC as such may be too high, for example if there are numerous target cell preparations, which, in some embodiments, may turn out as unnecessary.

In some embodiments, this issue may be tackled, for example, by an a-posteriori MRO-based approach, which may e.g. use the counter CNT and/or key performance indicator (KPI) statistics, for example derivable from the first information I-1 and/or the second information I-2, as may be determined according to some embodiments, for example to adapt a parameter setting, i.e. to adapt a configuration of the A3_prep measurement event, which may e.g. be derived from the right balance of unnecessary target cell preparations and too late preparation, while too late preparations resulting in RLFs should get higher weights.

In other words, in some embodiments, at least one measurement event related to CHO and/or CPC and/or CPA—or at least one parameter associated with the at least one measurement event—may be determined or modified based on the first information I-1 and/or the second information I-2 and/or based on at least one parameter CNT, CP which may be derived from the first information I-1 and/or the second information I-2.

In some embodiments, based on e.g. the first information I-1 and/or the second information I-2 and/or based on at least one parameter CNT, CP which may be derived from the first information I-1 and/or the second information I-2, “unnecessary” target cell preparations for CHO and/or CPC/CPA may be determined.

In some embodiments, a detection of costly and/or unnecessary CHO/CPC/CPA preparation(s) can be, for instance, used to increase a counter like “unnecessary target cell preparation”, which in some embodiments may serve as a counterbalance to a counter “too late preparation”, for example to ensure that, for example MRO, may find an optimal balanced CHO/CPC/CPA preparation timing.

In other words, in some embodiments, a preparation timing for CHO and/or CPC and/or CPA may be determined and/or modified based on the first information I-1 and/or the second information I-2.

FIG. 12 schematically depicts a simplified flow chart according to some embodiments.

Element e1 exemplarily symbolizes a logging of a number of (possibly unnecessarily) prepared cells (e.g., using element N-1 of FIG. 5) and preparation activities (e.g., using element N-2 of FIG. 5), and/or other elements of the first information I-1. In some embodiments, the logging e1 may be based on the first information I-1 as may be obtained by the determining block 300 of FIG. 3. In some embodiments, the logging e1 of FIG. 12 may start with a first measurement triggering a CHO/CPC preparation.

Element e2 exemplarily symbolizes a determination whether the CHO or CPC is successfully completed. If not, the procedure returns to element e1. If it is determined that the CHO or CPC is successfully completed, the procedure continues with element e3 which exemplarily symbolizes a retrieval of logged data (see for example also block 400 of FIG. 8), for example comprising the first information I-1 or at least a part of the first information I-1.

Element e4 exemplarily symbolizes a determination whether a number N-1 of (unnecessarily) prepared cells and/or a number N-2 of preparation activities exceeds a, for example, respective threshold. If so, the procedure exemplary continues with elements e5, e6, wherein element e5 symbolizes incrementing a counter characterizing an amount of unnecessarily prepared cells and/or preparation actions, and wherein element e6 symbolizes an optional deletion. If yes, e.g. if the threshold(s) evaluated in element e4 is/are not exceeded, the procedure transitions from element e4 to element e6.

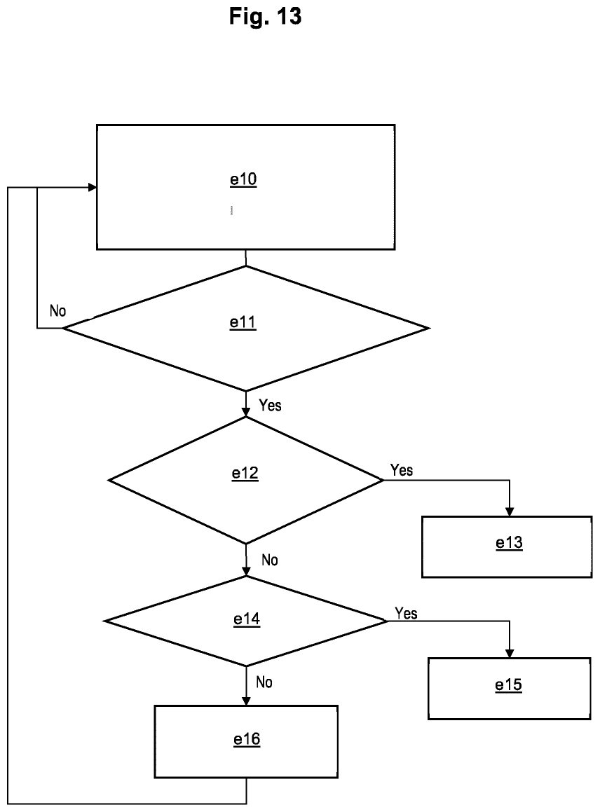

FIG. 13 schematically depicts a simplified flow chart according to some embodiments. Element e10 exemplarily symbolizes an MRO instance 30 monitoring MRO-specific Performance Counters being used for CHO/CPC, e.g. two counterbalancing performance counters, wherein a first counter characterizes “UNNECESSARY PREPARATION”, and wherein a second counter characterizes “TOO LATE PREPARATION”. In some embodiments, the monitoring e10 may e.g. be performed based on the first information I-1 and/or the second information I-2.

Element e11 symbolizes a determination as to whether a monitoring time has expired AND a statistical significance is sufficient. If not, the procedure returns to element e10. If yes, the procedure continues with element e12, which symbolizes a determination as to whether an UNNECESSARY PREPARATION (e.g. represented by the first counter mentioned above) exceeds a predetermined threshold AND whether a number of TOO LATE PREPARATION (e.g. represented by the second counter mentioned above) equals zero. If so, the procedures transitions to element e13, which symbolizes increasing an A3_prep-Offset value for a considered serving cell, e.g. for later preparation. If not, the procedure transitions to element e14, which symbolizes a determination as to whether the number of TOO LATE PREPARATION (e.g. represented by the second counter mentioned above) is greater than zero. If so, the procedure transitions to element e15, which symbolizes decreasing the A3_prep-Offset value for the considered serving cell, e.g. for earlier preparation. If not, the procedure transitions to element e16, which symbolizes keeping the A3_prep-Offset for the considered serving cell unchanged.

In some embodiments, the exemplary procedure depicted by FIG. 13 may be included in an MRO algorithm or procedure, for example to optimize the A_prep-Offset parameter. In other embodiments, different MRO procedures may be performed, e.g. based on the first information I-1 and/or the second information I-2, which may be obtained according to some embodiments.

In some embodiments, as mentioned above, the principle according to the embodiments may also be applied to MR-DC, wherein, for example, the logging of data (e.g., determining and/or storing for example the first information I-1 and/or the second information I-2), e.g. for a conditional PSCell preparation, can be done in the MN and/or in the SN, for example depending on the node that is responsible for the PSCell changes and/or additions (CPC and CPA). In some embodiments, this responsibility is implementation specific, and not specified in currently accepted standards.

In some embodiments, e.g. if the MN of the MR-DC configuration is logging as in case of CHO, a memory foreseen for UE specific data storage (e.g. UE context) may be extended by at least two integer variables, for example for storing a number of prepared PSCells and a number of preparation activities, e.g. similar to elements N-1, N-2 of FIG. 5. In some embodiments, and different from the case of CHO, the logged data may be retrieved by the MRO instance 30 and may be analyzed, e.g. when MN receives an RRC Reconfiguration Complete message, e.g. according to some accepted standards, from the UE 20 indicating completing of SN change.

In some embodiments, e.g. when SN is logging, the UE context at the SN may be extended, as explained for the MN above. In some embodiments, if the MRO instance 30 is at the SN, then the logged data may be retrieved by the MRO instance and may be analyzed when receiving e.g. UE context release from the MN or an indication from MN that the CPC execution condition is met for a specific target PSCell. On the other hand, if, in some embodiments, the MRO instance 30 is at the MN, then the logged information may be transferred from the SN to the MN, e.g. via XnAP messaging, for example after SN receives e.g. a UE context release from the MN. In some embodiments, for that purpose, existing procedures, such as an RRC_TRANSFER according to some accepted standards, may be used, and/or a new message may be defined.

In some embodiments, a Successful Handover Report, for example according to some accepted standards, may be fetched by the network and may be propagated back, e.g. to a network node 30 (FIG. 3) running an MRO algorithm e.g. acting on an unnecessary preparation of the cells, e.g. to optimize a timing for the CHO preparation.

In some embodiments, in case of MR-DC, the terminal device 20 can log similar information as explained above with respect to the first information I-1 and/or the second information I-2. In some embodiments, e.g. for CPC/CPA, a PCI of the prepared PSCells may be logged, and/or PCI of the prepared PSCells which have been released before CPC/CPA execution may be logged, and/or PCIs of the PSCells which have been prepared and released before CPC/CPA execution along with their order may be included and/or the terminal device 20 may log the PCI of the PSCell to which CPC/CPA is executed.

In some embodiments, the information exemplary listed in the preceding paragraph may e.g. be fetched by the network and may be propagated to a network node 30 running an MRO algorithm with a new report, and/or by using a Successful Handover Report, which in some embodiments may be defined for the secondary link.

In some embodiments, the envisaged SON/MRO algorithm related to evaluating the first information I-1 and/or the second information I-2, may be realized as a centralized function, for example located in an Operation, Administration and Maintenance (OAM) domain, e.g. with SON/MRO agents running in a Radio Access Network (RAN) domain where relevant aspects related to a mobility procedure in question may be collected and/or (pre-) analyzed. In some embodiments, signaling aspects or mechanisms, e.g. from OAM (north-bound I/F) like activating and configuring parameters the corresponding MRO feature and/or new KPIs/counters to the OAM may be provided.

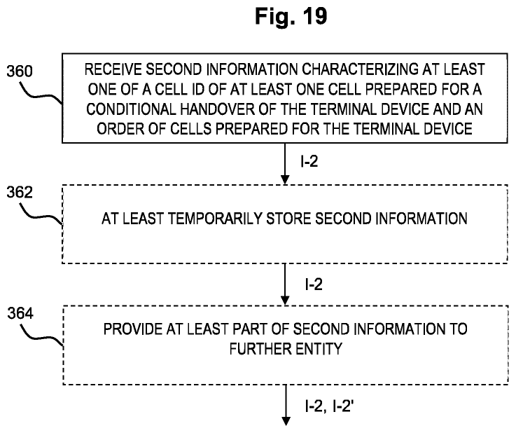

Further exemplary embodiments relate to an apparatus 500 comprising at least one processor 502, and at least one memory 504 storing instructions 506, the at least one memory 504 and the instructions 506 configured to, with the at least one processor 502, cause a network device 50 (FIG. 3) to receive 360 (FIG. 19) an information, for example a second information, I-2 characterizing at least one of a) a cell ID C-ID′ (FIG. 7) of at least one cell prepared for a conditional handover or a conditional primary secondary cell change of a terminal device, b) an order C-ORD′ of cells prepared for the terminal device, c) a cell ID C-ID″ of at least one cell prepared for the terminal device which has been released before an execution of the conditional handover or the conditional primary secondary cell change, d) an order C-ORD″ of cells prepared for the terminal device which has been released before an execution of the conditional handover or the conditional primary secondary cell change, e) a cell, for example cell ID C-ID′″ of a cell, to which the conditional handover or the conditional primary secondary cell change has been successfully executed.

In some embodiments, the network device 50 may thus receive the second information I-2 from one or more UE 20.

In some embodiments, the instructions 506, when executed by the at least one processor 502, further cause the network device 50 to at least temporarily store 362 (FIG. 19) the second information I-2.

In some embodiments, the instructions 506, when executed by the at least one processor 502, further cause the network device 50 to provide 364 at least a part I-2′ of the second information I-2 to at least one further entity 30.

Further exemplary embodiments, FIG. 18, relate to an apparatus 500′ comprising means 502′ for causing a network device 50 to receive an information, for example a second information, I-2 (see for example FIG. 7) characterizing at least one of a) a cell ID, b) an order of cells prepared for the terminal device, c) a cell ID of at least one cell prepared for the terminal device which has been released before an execution of the conditional handover or the conditional primary secondary cell change, d) an order of cells prepared for the terminal device which has been released before an execution of the conditional handover or the conditional primary secondary cell change, e) a cell, for example cell ID of a cell, to which the conditional handover or the conditional primary secondary cell change has been successfully executed.

Further exemplary embodiments, FIG. 19, relate to a method, comprising: receiving 360 an information, for example a second information, I-2 characterizing at least one of a) a cell ID of at least one cell prepared for a conditional handover or a conditional primary secondary cell change of a terminal device, b) an order of cells prepared for the terminal device, c) a cell ID of at least one cell prepared for the terminal device which has been released before an execution of the conditional handover or the conditional primary secondary cell change, d) an order of cells prepared for the terminal device which has been released before an execution of the conditional handover or the conditional primary secondary cell change, e) a cell, for example cell ID of a cell, to which the conditional handover or the conditional primary secondary cell change has been successfully executed, the method further comprising: determining, based on at least one of the first information and the second information, a cost parameter characterizing a cost and/or an effort associated with the conditional handover or the conditional primary secondary cell change of the terminal device.

1-21. (canceled)

22. An apparatus, comprising at least one processor, and at least one memory storing instructions, the at least one memory and the instructions configured to, with the at least one processor, cause a network device to determine a first information (I-1) characterizing at least one of a) a number (N-1) of cells prepared for a conditional handover or a conditional primary secondary cell change of a terminal device, b) a number (N-2) of preparation activities associated with the conditional handover or the conditional primary secondary cell change of the terminal device.

23. The apparatus according to claim 22, wherein the first information (I-1) further comprises at least one of: c) a cell ID (C-ID) of at least one cell prepared for the terminal device during a predetermined time span, d) a time duration (T-D) a cell has been prepared for the terminal device, for example before being released or until the conditional handover or the conditional primary secondary cell change is made, e) an order (C-ORD) of cells prepared for the terminal device.

24. The apparatus according to claim 22, wherein the instructions, when executed by the at least one processor, further cause the network device to: at least temporarily store the first information (I-1).

25. The apparatus according to claim 22, wherein the instructions, when executed by the at least one processor, further cause the network device to: provide the first information (I-1) to at least one further entity.

26. An apparatus comprising at least one processor, and at least one memory storing instructions, the at least one memory and the instructions configured to, with the at least one processor, cause a terminal device to determine an information (I-2), for example a second information (I-2), characterizing at least one of a) a cell ID (C-ID′) of at least one cell prepared for a conditional handover or a conditional primary secondary cell change of the terminal device, b) an order (C-ORD′) of cells prepared for the terminal device, c) a cell ID (C-ID″) of at least one cell prepared for the terminal device which has been released before an execution of the conditional handover or the conditional primary secondary cell change, d) an order (C-ORD″) of cells prepared for the terminal device which has been released before an execution of the conditional handover or the conditional primary secondary cell change, e) a cell, for example cell ID (C-ID′″) of a cell, to which the conditional handover or the conditional primary secondary cell change has been successfully executed.

27. The apparatus according to claim 26, wherein the instructions, when executed by the at least one processor, further cause the terminal device to at least temporarily store (the second information (I-2).

28. The apparatus according to claim 26, wherein the instructions, when executed by the at least one processor, (further cause the terminal device to provide at least a part of the second information (I-2) to at least one further entity.

29. The apparatus according to claim 28, wherein providing at least a part of the second information (I-2) to the at least one further entity comprises including the at least one part of the second information (I-2) in a Successful Handover Report.

30. An apparatus, comprising at least one processor, and at least one memory storing instructions, the at least one memory and the instructions configured to, with the at least one processor, retrieve at least one of a first information (I-1) and a second information (I-2), the first information (I-1) characterizing at least one of a) a number (N-1) of cells prepared for a conditional handover or a conditional primary secondary cell change of a terminal device, b) a number (N-2) of preparation activities associated with the conditional handover or the conditional primary secondary cell change of the terminal device, the second information (I-2) characterizing at least one of a) a cell ID (C-ID′) of at least one cell prepared for a conditional handover or a conditional primary secondary cell change of the terminal device, b) an order (C-ORD′) of cells prepared for the terminal device, c) a cell ID (C-ID″) of at least one cell prepared for the terminal device which has been released before an execution of the conditional handover or the conditional primary secondary cell change, d) an order (C-ORD″) of cells prepared for the terminal device which has been released before an execution of the conditional handover or the conditional primary secondary cell change, e) a cell, for example cell ID (C-ID′″) of a cell, to which the conditional handover or the conditional primary secondary cell change has been successfully executed, and to: determine, based on at least one of the first information (I-1) and the second information (I-2), a cost parameter (CP) characterizing a cost and/or an effort associated with the conditional handover or the conditional primary secondary cell change of the terminal device.

31. An apparatus comprising at least one processor, and at least one memory storing instructions, the at least one memory and the instructions configured to, with the at least one processor, cause a network device to receive an information (I-2), for example a second information (I-2), characterizing at least one of a) a cell ID (C-ID′) of at least one cell prepared for a conditional handover or a conditional primary secondary cell change of a terminal device, b) an order (C-ORD′) of cells prepared for the terminal device, c) a cell ID (C-ID″) of at least one cell prepared for the terminal device which has been released before an execution of the conditional handover or the conditional primary secondary cell change, d) an order (C-ORD″) of cells prepared for the terminal device which has been released before an execution of the conditional handover or the conditional primary secondary cell change, e) a cell, for example cell ID (C-ID′″) of a cell, to which the conditional handover or the conditional primary secondary cell change has been successfully executed.

32. The apparatus according to claim 31, wherein the instructions, when executed by the at least one processor, further cause the network device to at least temporarily store the second information (I-2).

33. The apparatus according to claim 31. wherein the instructions, when executed by the at least one processor, further cause the network device to provide at least a part (I-2′) of the second information (I-2) to at least one further entity.
